(19) United States
(12) Patent Application Publication
(10) Pub. No.: US 2007/0256308 A1
(43) Pub. Date: Nov. 8, 2007

(54) Pruners with replaceable part

(76) Inventor: Chorng-Jiang Lin, Cingshuei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/418,060

(22) Filed: May 5, 2006

(51) Int. Cl. B26B 13/00

(52) U.S. Cl. 30/231

(57) ABSTRACT

A pair of pruners includes two blades with two handles integrally connected thereto. The two handles are pivotably connected with each other, and one of the two handles has an insertion port and a snapping portion on two ends thereof. A replaceable part is connected to the insertion port. The replaceable part can be a finger protection member, an end piece or a function part. A key is connected to one of the two handles so as to control the width that the two blades can be opened.

### FIELD OF THE INVENTION

The present invention relates to a pair of pruners which are easily to be assembled and having replaceable parts for different purposes of use.

### BACKGROUND OF THE INVENTION

A conventional pair of pruners generally includes two blades and two handles which are pivotably connected with each other. Some of the blades are designed to have special shapes so as to cut the plants with less effort. Some conventional pruners provide enhanced mechanism to increase the cutting force. Some pruners include a hanging mechanism which allows the users to hang the pruners on a wall or to be attached to the user's belt. Nevertheless, all of the conventional pruners in the market have a fixed function and which is not changeable. In other words, the users have to prepare another type of tools such as a screw driver when using the pruners in gardens and need a screw driver to tighten or loosen some screws.

The present invention intends to provide a pair of pruners which includes replaceable parts which can be a blade, a screw driver bit or any known tools so that the pruners have at least two different functions.

### SUMMARY OF THE INVENTION

The present invention relates to a pair of pruners which includes two blades and two handles are integrally connected to the two blades. The two handles are pivotably connected with each other, and one of the two handles has an insertion port. A replaceable part is connected to the insertion port. The replaceable part can be a finger protection member, an end piece or a function part. The finger protection member has an engaging end for being engaged with the insertion port, and a hooking end for being connected to a snapping portion of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pair of pruners of the present invention;

FIG. 2 is a perspective view to show one of the two handles of the pruners of the present invention;

FIG. 3 shows a finger protection member is connected to one of the handles;

FIG. 4 is a cross sectional view to show that the finger protection member is connected to one of the handles;

FIG. 5 shows that the end piece is connected to one of the tow handles, and

FIG. 6 shows the function part to be connected to one of the tow handles.

### DETAILED DESCRIPTION OF THE PREFERRED EMBODIMENT

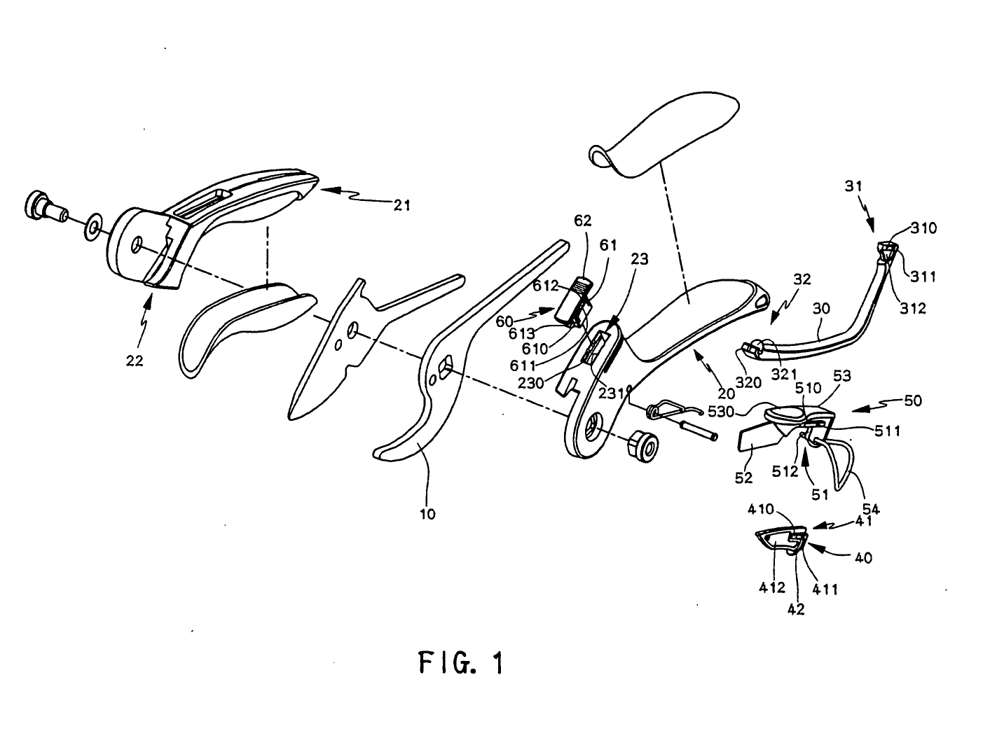

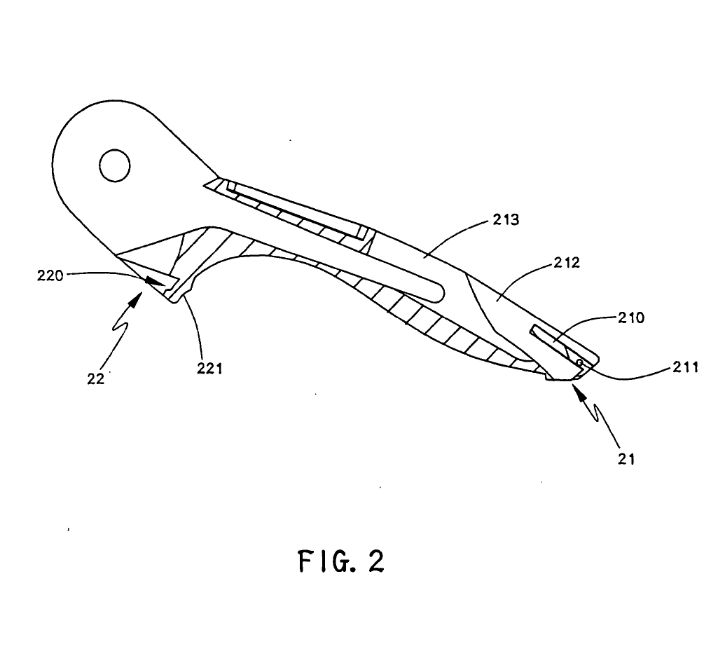

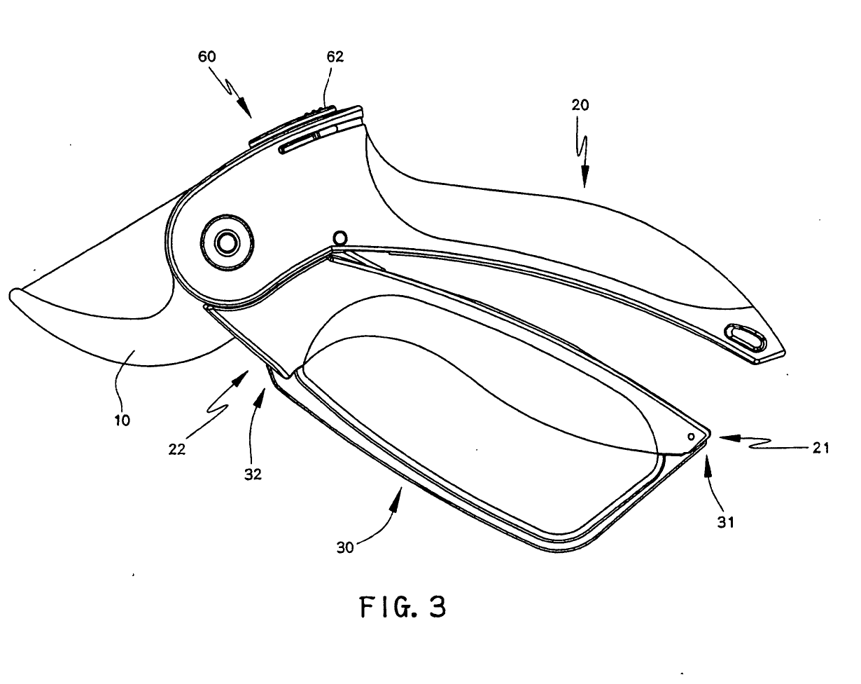

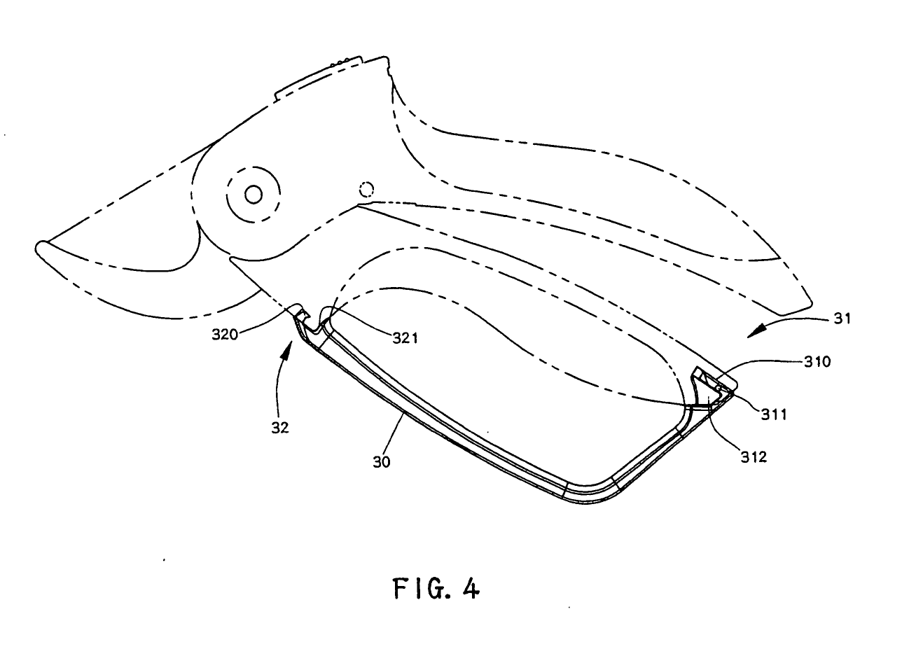

Referring to FIGS. 1 to 4, the pruners of the present invention comprises two blades 10 and two handles 20 are integrally connected to the two blades 10. The two handles 20 are pivotably connected with each other by a pin so that when the two handles 20 are pivoted toward each other, the two blades 10 are moved toward each other to cut objects. One of the two handles 20 has an insertion port 21 and a triangular snapping portion 22 on two ends thereof. The insertion port 21 of the handle 20 includes a recess 210 defined therein which has two positioning bosses 211 on two inside walls thereof. A space 212 is defined in the handle 20 at the end having the insertion port 21 and communicates with a narrow tool space 213.

A replaceable part can be removably connected to the insertion port 21 as needed. The replaceable part can be a finger protection member 30, an end piece 40 or a function part 50.

The finger protection member 30 has an engaging end 31 and a hooking end 32. The engaging end 31 includes a protrusion 310 and two dents 311 are defined in two sides of the protrusion 310. The protrusion 310 is inserted into the recess 210 of the handle 20 and the two dents 311 are engaged with positioning bosses 211. The snapping portion 22 of the handle 20 includes a concavity and a notch 220 is defined in an inner end of the concavity. A matching contour 221 is defined in an outside of the concavity and located corresponding to the notch 220. The hooking end 32 of the finger protection member 30 includes a hook 320 and a matching part 321, wherein the hook 320 is hooked with the notch 220 of the snapping portion 22 of the handle 20 and the matching part 321 is engaged with the matching contour 221. The finger protection member 30 is easily to be assembled to the handle 20 and protected user's the fingers when using the pruners.

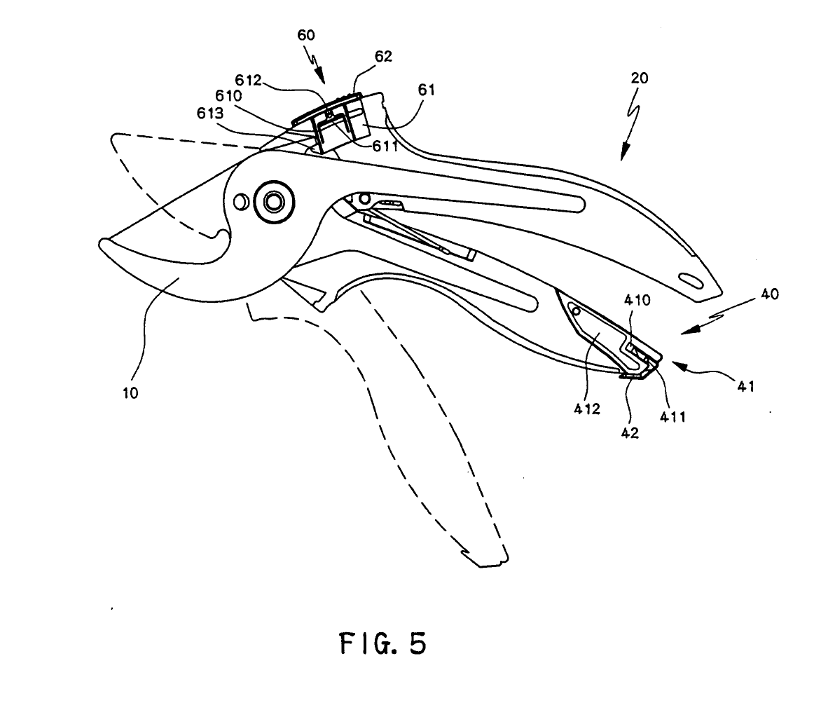

Referring to FIG. 5, the end piece 40 includes an engaging end 41 which includes a protrusion 410 and dents 411 are defined in two sides thereof. The engaging end 41 is engaged with the recess 210 of the insertion port 21 of the handle 20 and the dents 411 are engaged with the positioning bosses 211. A cover 42 is connected to the end piece 40 so as to cover the insertion port 21.

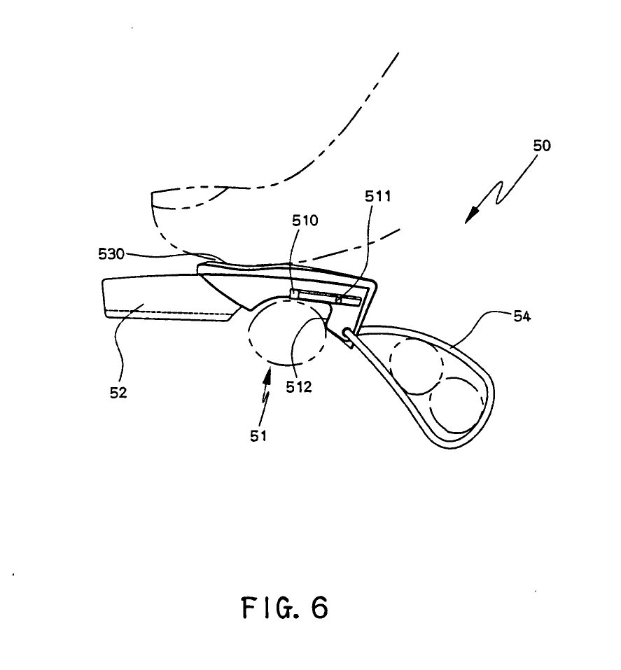

As shown in FIG. 6, the function part 50 is to be connected to the insertion port 21 and includes an engaging end 51 which has a protrusion 510 with two dents 511 defined in two sides thereof. The protrusion 510 has an insertion 512 which is inserted into the insertion port 21. A tool head 52 extends from the insertion 512 of the protrusion 510 of the function part 50 and the tool head 52 extends toward the tool space 213 in the handle 20. The insertion 512 of the function part 50 has a cover 53 to seal the insertion port 21. The tool head 52 can be a keystone tip, a blade or any known function tip. The cover 53 has a friction surface 530 and the cover 53 has a flexible collar 54 connected thereto. The user may insert two fingers into the collar 54 and use the thumb to push on the friction surface 530 to operate the tool head 52.

Referring to FIGS. 1 and 5, the other one of the two handles 20 has a keyway 23 defined therein which is a rectangular recess and a key 60 is movably engaged with the keyway 23. The keyway 23 in the handle 20 includes dents 230 defined in two inside walls thereof and the dents 230 are orientated in vertical position. Two sliding portion 231 are defined in the two inside walls of the keyway 23 and orientated in horizontal direction. The key 60 includes two ridges 611 and positioning bosses 612 on two sides thereof. The ridges 611 are removably engaged with sliding portions 231 of the handle 20 and the positioning bosses 612 are removably engaged with dents 230 in the handle 20. The key 60 has a rectangular body 61 which has a pushing end 62 on one end of the body 61. The body 61 includes slits 610 defined two sides thereof and the ridge 611 and the positioning bosses 612 are on the two sides of the body 61. The other end of the body 61 has a stop end 613.

The engagement between the ridges 611 and the sliding portions 231 limits the key 60 to be moved linearly and the engagement between the positioning bosses 612 and the dents 230 provides a click feeling to the user so as to control the width of the opening of the two blades 10. The stop end 613 controls the open and close status of the two blades 10.

While we have shown and described the embodiment in accordance with the present invention, it should be clear to those skilled in the art that further embodiments may be made without departing from the scope of the present invention.

What is claimed is:

1. A pair of pruners comprising:
two blades (10) and two handles (20) which are integrally connected to the two blades (10), the two handles (20) pivotably connected with each other, one of the two handles (20) having an insertion port (21) and a snapping portion (22) on two ends thereof, and
a finger protection member (30) having an engaging end (31) and a hooking end (32), the engaging end (31) being engaged with the insertion port (21) and the hooking end (32) being connected to the snapping portion (22).

2. The pruners as claimed in claim 1, wherein the insertion port (21) of the handle (20) includes a recess (210) defined therein which has two positioning bosses (211) on two inside walls thereof, a space (212) is defined in the handle (20).

3. The pruners as claimed in claim 2, wherein the snapping portion (22) of the handle (20) includes a concavity and a notch (220) is defined in an inner end of the concavity, a matching contour (221) is defined in an outside of the concavity and located corresponding to the notch (220).

4. The pruners as claimed in claim 3, wherein the engaging end (31) of the finger protection member (30) includes a protrusion (310) and two dents (311) are defined in two sides of the protrusion (310) so as to be engaged with positioning bosses (211), the protrusion (310) is inserted into the space (212) of the handle (20), the hooking end (32) of the finger protection member (30) includes a hook (320) and a matching part (321), the hook (320) is hooked with the notch (220) of the snapping portion (22) of the handle (20) and the matching part (321) is engaged with the matching contour (221).

5. A pair of pruners comprising:
two blades (10) and two handles (20) which are integrally connected to the two blades (10), the two handles (20) pivotably connected with each other, one of the two handles (20) having an insertion port (21) and a snapping portion (22) on two ends thereof, and
an end piece (40) including an engaging end (41) which is engaged with the insertion port (21) of the handle (20), a cover (42) connected to the end piece (40) so as to cover the insertion port (21).

6. The pruners as claimed in claim 5, wherein the insertion port (21) of the handle (20) includes a recess (210) defined therein which has two positioning bosses (211) on two inside walls thereof, a space (212) is defined in the handle (20).

7. The pruners as claimed in claim 6, wherein the engaging end (41) of the end piece (40) includes a protrusion (410) which has dents (411) defined in two sides thereof so as to be engaged with the positioning bosses (211).

8. A pair of pruners comprising:
two blades (10) and two handles (20) which are integrally connected to the two blades (10), the two handles (20) pivotably connected with each other, one of the two handles (20) having an insertion port (21) and a snapping portion (22) on two ends thereof, and
a function part (50) connected to the insertion port (21) and including an engaging end (51), a tool head (52) extending from the function part (50).

9. The pruners as claimed in claim 8, wherein the insertion port (21) of the handle (20) includes a recess (210) defined therein which has two positioning bosses (211) on two inside walls thereof, a space (212) is defined in the handle (20) and communicates with a narrow tool space (213).

10. The pruners as claimed in claim 9, wherein the engaging end (51) of the function part (50) has a protrusion (510) which has two dents (511) defined in two sides thereof, the protrusion (510) has an insertion (512) which is inserted into the insertion port (21), the tool head (52) extends from the insertion (512) of the protrusion (510) of the function part (50 and the tool head (52) extends toward the tool space (213) in the handle (20), the insertion (512) of the function part (50) has a cover (53) to seal the insertion port (21).

11. The pruners as claimed in claim 10, wherein the tool head (52) is a keystone tip.

12. The pruners as claimed in claim 10, wherein the cover (53) has a friction surface (530).

13. The pruners as claimed in claim 12, wherein the cover (53) has a flexible collar (54) connected thereto.

14. A pair of pruners comprising:
two blades (10) and two handles (20) which are integrally connected to the two blades (10), the two handles (20) pivotably connected with each other, one of the two handles (20) having a keyway (23) defined therein, and
a key (60) movably engaged with the keyway (23) and includes ridges (611) and positioning bosses (612), the ridges (611) removably engaged with two sliding portions (231) of the handle (20) and the positioning bosses (612) are removably engaged with dents (230) in the handle (20).

15. The pruners as claimed in claim 14, wherein the keyway (23) in the handle (20) is a rectangular recess and the dents (230) are defined in two inside walls of the keyway (23), the dents (230) are orientated in vertical position, the sliding portions (231) are defined in the two inside walls of the keyway (23) and orientated in horizontal direction.

16. The pruners as claimed in claim 14, wherein the key (60) has a body (61) which has a pushing end (62) on one end of the body (61), the body (61) includes slits (610) defined two sides thereof and the ridges (611) and the positioning bosses (612) are on the two sides of the body (61), the other end of the body (61) has a stop end (613).

17. A pair of pruners comprising:
two blades (10) and two handles (20) which are integrally connected to the two blades (10), the two handles (20) pivotably connected with each other, one of the two handles (20) having an insertion port (21), and
a replaceable part connected to the insertion port (21).

18. The pruners as claimed in claim 17, wherein the replaceable part is a finger protection member (30), an end piece (40) or a function part (50).
